(19) United States
(12) Patent Application Publication
(10) Pub. No.: US 2018/0132441 A1
(43) Pub. Date: May 17, 2018

(54) HYDROPONIC CONVEYOR SYSTEM AND METHOD OF GROWING AND HARVESTING CROPS

(71) Applicants: Alvin Harker, New Harmony, UT (US); Brig Jeffs, New Harmony, UT (US); James Barlow, Colorado City, AZ (US); James Harker, Colorado City, UT (US); Nathan Jessop, Hildale, UT (US); Sam Williams, Colorado City, AZ (US); Thomas Harker, Hurricane, UT (US); Carl Timpson, Hildale, UT (US); Robert Harker, Hurricane, UT (US)

(72) Inventors: Alvin Harker, New Harmony, UT (US); Brig Jeffs, New Harmony, UT (US); James Barlow, Colorado City, AZ (US); James Harker, Colorado City, UT (US); Nathan Jessop, Hildale, UT (US); Sam Williams, Colorado City, AZ (US); Thomas Harker, Hurricane, UT (US); Carl Timpson, Hildale, UT (US); Robert Harker, Hurricane, UT (US)

(21) Appl. No.: 15/815,676

(22) Filed: Nov. 16, 2017

Related U.S. Application Data
(60) Provisional application No. 62/423,094, filed on Nov. 16, 2016.

(51) Int. Cl. A01G 31/04; B65G 47/34; A01G 7/04

(52) U.S. Cl. CPC A01G 31/042; A01G 31/06; A01G 7/045; B65G 47/34

(57) ABSTRACT

A method of using conveyor belts for hydroponic growing includes distributing seeds onto at least one conveyor belt, watering the seeds on the conveyor belt, providing lighting to the conveyor belt to facilitate photosynthesis of the seeds thereon, advancing the conveyor belt in intervals as the seeds sprout and grow, and harvesting the sprouts at the end of the conveyor belt.

### CROSS-REFERENCE TO RELATED APPLICATIONS

This application claims the benefit of U.S. Provisional Application Ser. No. 62/423,094 filed on Nov. 16, 2016, which is incorporated herein by reference.

### TECHNICAL FIELD

The present disclosure relates to agriculture. More particularly, the present disclosure relates to a hydroponic conveyor system for growing and harvesting crops.

### BACKGROUND

Growing and harvesting crops year-round has always been a challenge. During various seasons, harvested crops must generally be shipped from one location to another in an effort to fulfill the need for fresh crops in areas that cannot produce crops—such as during the winter months. Indoor agricultural farms aren't practical, so other methods have been developed. One method is hydroponics. Hydroponics is a method of growing plants without soil, and typically uses water that is often combined with various nutrient solutions. However, typical hydroponic facilities are often too expensive and produce too few of crops to be useful in commercial and livestock feed scenarios, where crops may be needed daily. Hydroponic facilities are often very large as well, and encounter the same drawbacks as indoor agricultural farms in that sense.

Therefore, there is a need for a hydroponic system that can produce crops quickly and efficiently, without requiring large amounts of space or real estate, and where the crops can be harvested regularly—including daily in many instances. The present invention seeks to solve these and other problems.

### SUMMARY OF EXAMPLE EMBODIMENTS

A hydroponic conveyor system comprises at least one conveyor belt, a seed distributor for distributing seeds onto the conveyor belt, a hydration system, a plurality of light-emitting diodes, and an HVAC system.

A hydroponic conveyor system comprises a plurality of conveyor belts stacked vertically in a rack, the conveyor belts forming rows in the rack, with the rack having a plurality of columns, a plurality of seed distributors located in the first column of the rack for distributing seeds onto the plurality of conveyor belts, a hydration system comprising a moveable hydration arm in each row of the rack, each movable arm having a plurality of drippers for dripping water, a plurality of light-emitting diodes in each row of the rack, the light-emitting diodes facilitating photosynthesis, an HVAC system, and an automation control system, wherein the automation control controls the speed of the conveyor belts and the timing of the hydration system.

A method of using conveyor belts for hydroponic growing comprises distributing seeds onto at least one conveyor belt, watering the seeds on the conveyor belt, providing lighting to the conveyor belt to facilitate photosynthesis of the seeds thereon, advancing the conveyor belt in intervals as the seeds sprout and grow, and harvesting the sprouts at the end of the conveyor belt.

### BRIEF DESCRIPTION OF THE DRAWINGS

FIG. 1 illustrates seeds being placed onto a conveyor belt of a hydroponic conveyor system;

FIG. 2 illustrates the seeds being leveled as the conveyor belt advances, to ensure an even distribution, of a hydroponic conveyor system;

FIG. 3 illustrates the hydration system, with water dripping onto the seeds as the moveable hydration arm moves along the length of the conveyor belt of a hydroponic conveyor system;

FIG. 4 illustrates two racks, each with a plurality of conveyor belts;

FIG. 5 illustrates a zone of sprouted seeds next to a zone of seeds that have not yet sprouted;

FIG. 6 illustrates the continuous progression of the sprouts on the conveyor belt, nearing a stage to be harvested;

FIG. 7 illustrates sprouts ready to be harvested by falling off of the conveyor belt;

FIG. 8 illustrates sprouts ready to be harvested by falling off of the conveyor belt;

FIG. 9 illustrates the sprouts as they are received on the outfeed conveyor;

FIG. 10 illustrates the sprouts exiting the structure on the outfeed conveyor;

FIG. 11 illustrates the sprouts being conveyed to a shredder (or to a truck for transportation, depending upon implementation);

FIG. 12 illustrates the sprouts being conveyed to a shredder (or to a truck for transportation, depending upon implementation);

FIG. 13 illustrates a shredder shredding the sprouts;

FIG. 14 illustrates the sprouts being conveyed into a container;

FIG. 15 illustrates cattle eating sprouts as the sprouts exit on an outfeed conveyor; and

FIG. 16 illustrates enclosed rows of conveyor belts in a rack of a hydroponic conveyor system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As will be appreciated from this disclosure, the present hydroponic conveyor system for growing and harvesting crops significantly increases agricultural growth, regardless of the season. As used throughout the disclosure, the term “sprouts” refers to any seed capable of sprouting.

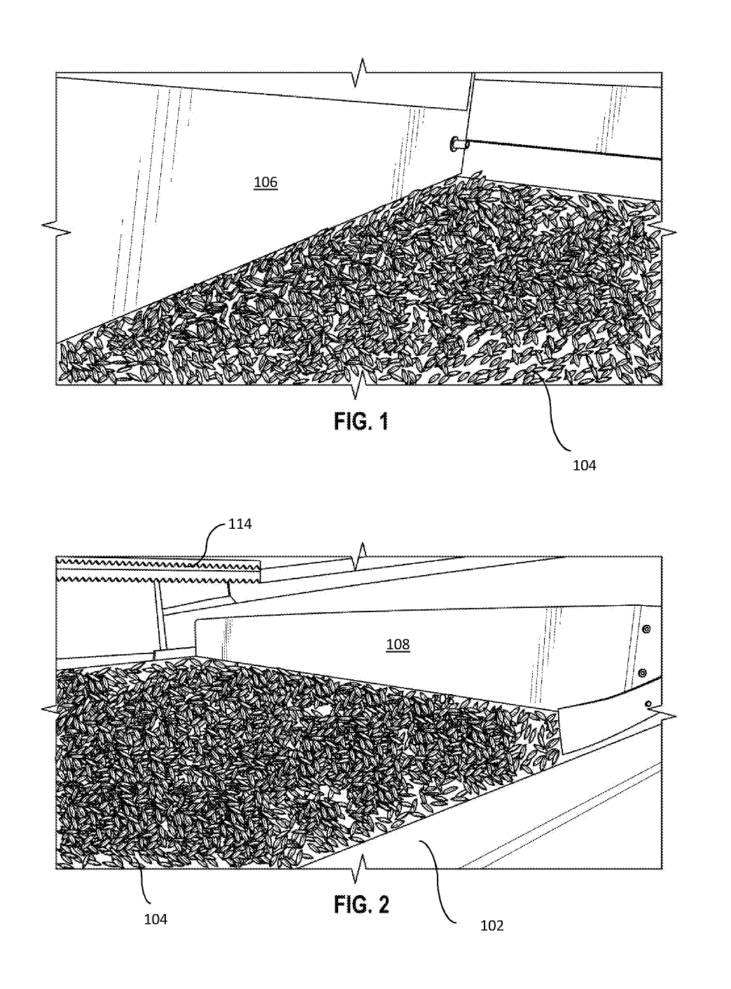

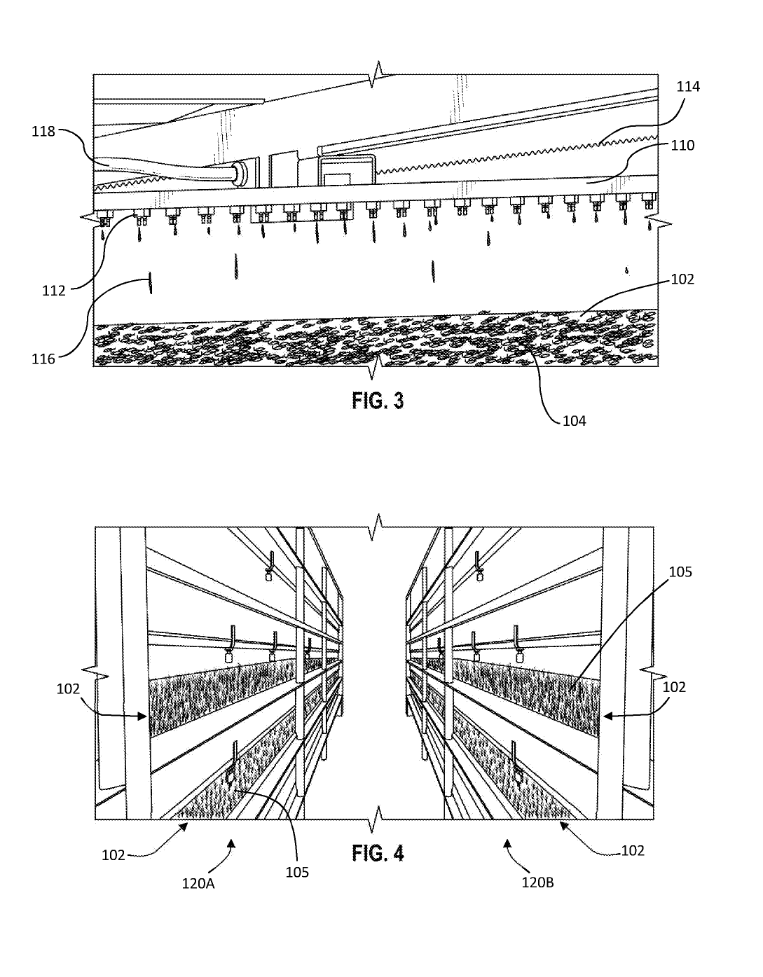

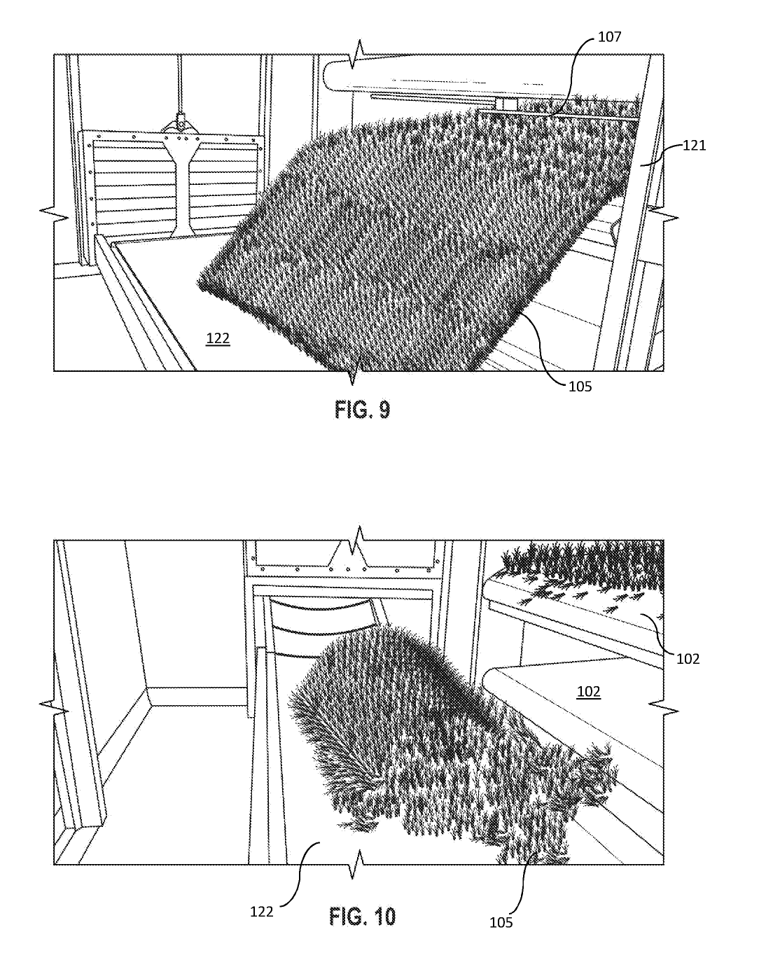

In one embodiment, as generally illustrated in FIGS. 1-10, a hydroponic conveyor system comprises one or more conveyor belts 102 that transport the seeds 104 through a series of progressive stations (or columns). In the first steps of the process, as shown in FIG. 1, seeds 104 are distributed onto a conveyor belt 102 via a hopper 106. In FIG. 2, the seeds may then pass under a distribution arm 108 that ensures the seeds are evenly distributed as the conveyor belt 102 progresses. The distribution arm is height adjustable so that the thickness of the seeds 104 on the conveyor belt 102 is also controlled. Once a section of the conveyor belt 102 is loaded with seeds 104, a hydration system may provide water to the seeds 104 on the conveyor belt 102. For example, as shown in FIG. 3, the hydration system comprises a moveable hydration arm 110 having a plurality of drippers 112 coupled thereto. The moveable hydration arm is coupled to a geared rack 114 (or other alternative, such as a chain system, pulley system, or similar) wherein the moveable hydration arm travels the length of the conveyor belt, dripping water 116 on the seeds 104. The water may be supplied to the moveable hydration arm via a tube 118 that is coupled to a water source. The movement of the moveable hydration arm, as well as the watering, is an automated process, with the moveable hydration arm advancing with the use of a motor (or equivalent system) that is programmable (e.g., using microcontrollers or equivalent).

The hydration system may receive water from a direct source or from one or more tanks. Tanks are beneficial for mixing nutrients with the water, thereby providing various nutrients to the seeds and sprouts. The tanks are a nutrient supplement system, which is designed to incubate, in a liquid solution, a culture of beneficial microbial organisms which can be distributed by the moveable hydration arm to points where the sprout will benefit from its effects the most. While drippers 112 are shown, it will be appreciated that other systems may also be used, such as dumping, jetting spraying, misting, or fogging. Further, the hydration system can be programmed to fit the needs of the sprouts being grown. Using a microcontroller or equivalent hardware, coupled to a user input system (e.g., keyboard, touchscreen, computer interface, smartphone application, etc.), the user may program the hydration system watering intervals, the length of the intervals, as well as the content of the nutrient mixture in the tanks. As shown in FIG. 4, a plurality of conveyor belts 102 are stacked vertically in rows, forming a rack 120A, 120B. The rows may be supported using a frame 121. Each conveyor belt 102 row has its own hydration system (i.e., each row of conveyor belts 102 in a rack 120A, 120B has a moveable hydration arm 110). As such, if a user is growing different seeds on the conveyor belts 102, each conveyor belt 102 can be programmed for the needs of the seeds on that level, which includes the interval and speed with which the conveyor belt 102 moves, the amount of hydration provided by the moveable hydration arm 110, as well as the source of water/nutrients. In other words, each row of conveyor belts 102 may use the same hydration source (e.g., a water tank) or may use different sources (e.g., different tanks with differing nutrient solutions tailored to the need of the sprout being grown). Additionally, a monitor (e.g., heat signature, color signature, and/or visual monitor such as a camera or webcam) could be mounted to the moveable hydration arm 110 (or other component) to monitor the status of the seeds/sprouts.

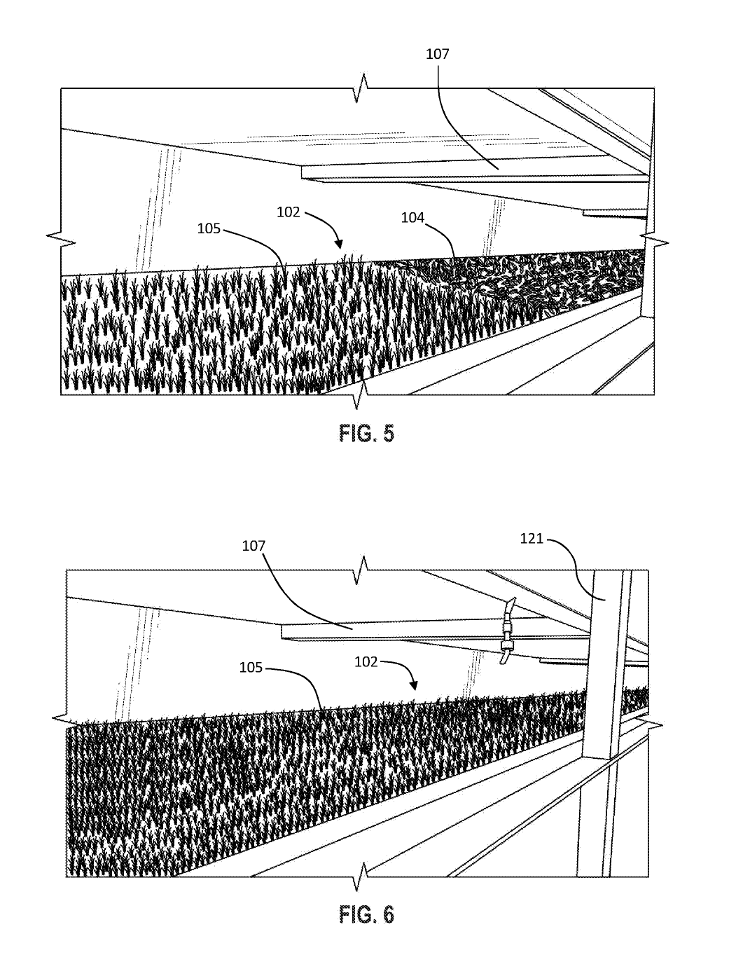

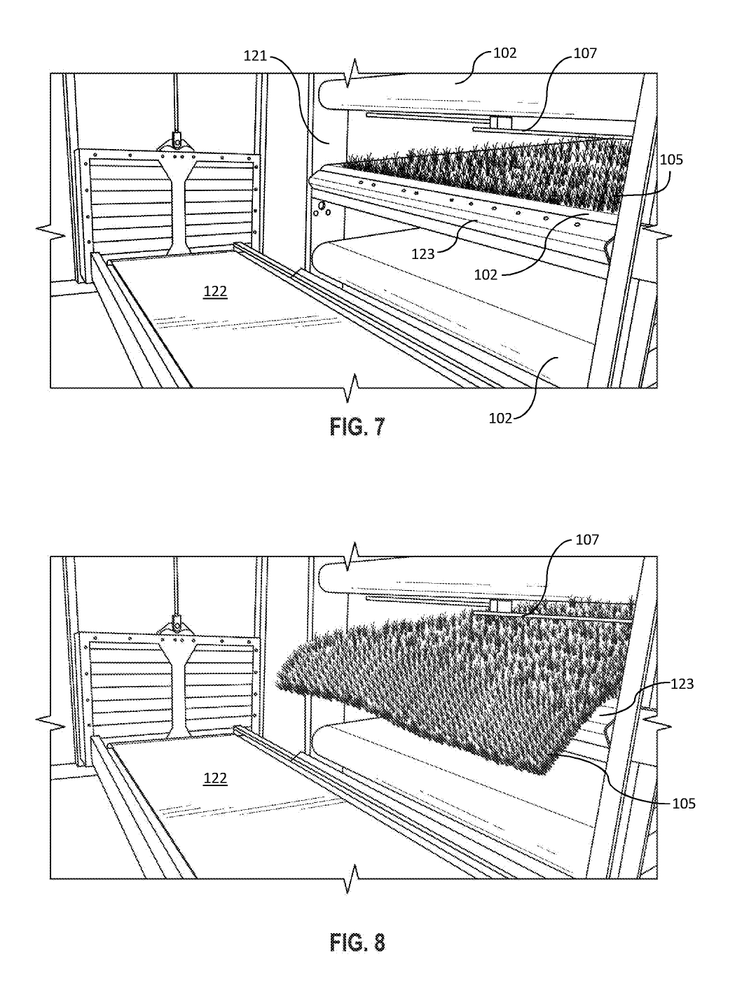

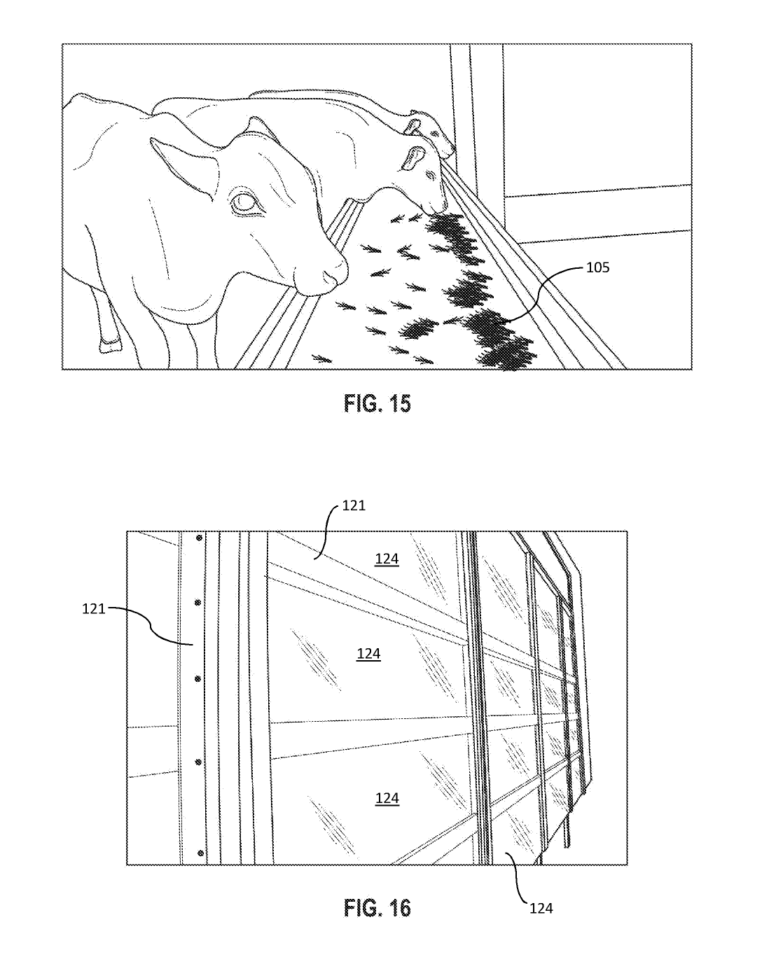

In one embodiment, water heaters may be used for the regulation of the temperature of the water to maximize the potential of germination in the germination zone. Each conveyor belt 102 is divided into several zones. For example, the first zone is illustrated in FIGS. 1-2, when seeds 104 are first placed on the conveyor belt. The following day, as shown in FIG. 5, the conveyor belt 102 may progress, moving the seeds 104 turned sprouts 105 to the next zone, which may include specific lighting and/or watering for that growing stage. As the first round of sprouts 105 progressed to the next zone, a new layer of seeds 104 were distributed onto the conveyor belt 102. This ensures a constant growth cycle of sprouts. Each day (or other programmable interval), the conveyor belt 102 moves. The zones at the end of the conveyor belt, as shown in FIG. 6, are different stages of growth for the sprouts, with each zone more mature than the previous zone. This continues until the first batch of seeds are harvested as sprouts, which is illustrated in FIGS. 7-10. In other words, the seeds at day seven have now sprouted and are ready to harvest. As such, on day eight, the first day's seeds are harvested, with sequential harvests continuing each day thereafter. As shown, the sprouts 105 fall off of the conveyor belt 102 as the conveyor belt cycles. The sprouts 105 are then ready for use, such as feeding to livestock, as shown in FIG. 15.

The moveable hydration arm 110 may be programmed to water at certain intervals, as well as controlling the amount of water released, in any given zone. If the sprout cycle is seven days in length, then each zone would make up 1/7^{th} the length of the conveyor belt. Accordingly, the size of each zone may vary according to the needs of the seed. Further, water-pretreatment, such as chlorination and sand filters, may also be incorporated. Water conditioning equipment is engineered to address the removal of unwanted or excess minerals that non-potable water sources may carry. If the installation location necessitates, additional equipment known in the art for well-source, or rain-collection cistern water supplies, may be used. If necessary, final water conditioning techniques known in the art, such as micro-filtration, pH balancing additives, or reverse osmosis equipment can be utilized. The hydroponic conveyor system may further comprise a compressed air line which has valves for the purging of condensed water.

Specific lighting may also be used that provides for optimal sprouting and growing of the seeds. The lighting may be produced by light-emitting diodes (LEDs) or other light-source that fosters photosynthesis. The lights 107 are positioned above the seeds 104 and sprouts 105 and may vary from zone to zone. Further, a reflective panel may be used to increase light intensity in any given zone. Similar to the conveyor belt 102 and moveable hydration arm 110, a programmable logic controller (PLC) may be used to control lighting intervals and intensity, as well as to switch between types of lights for differing color spectrums. This configuration ensures optimal growing.

In one embodiment, the hydroponic conveyor system further comprises an environmental control system (which comprises a heating and air conditioning (HVAC) system). The environmental control system can be used to create a thermal loop by utilizing waste heat from output sources to provide heat to other areas. This not only aids in growing, but also reduces overall operation costs. Excess heat energy transferred from the system may comprise a geothermal heat sink for summer conditions and a heat source for winter conditions.

In one embodiment, the zones are divided into two environmental sections for optimal growing conditions. In the germination section, the temperature and humidity are maintained at a higher level than the growing section. In the growing section, the sprout is kept at cooler and dryer temperatures, with proper air circulation, to maintain conditions that will optimize growth and inhibit mold and bacteria. The installation of air handlers and circulation fans, in combination with plenum walls, doors, and curtains 124 (shown in FIG. 16), create the air flow needed for proper distribution of humidity and temperature within the plenum space.

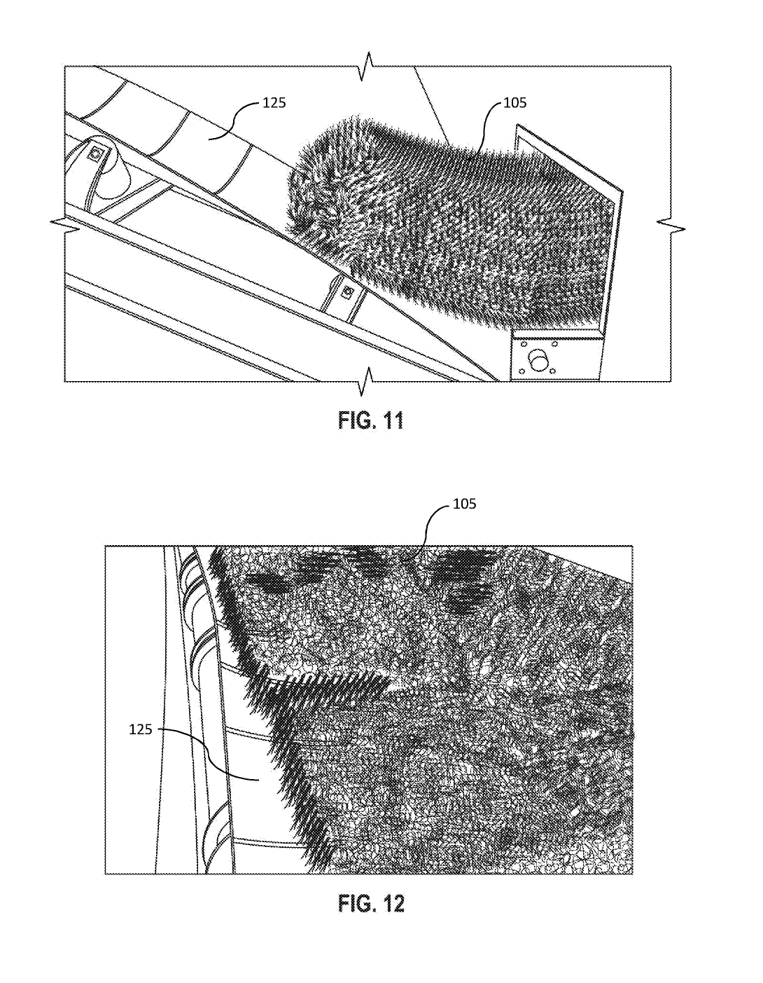

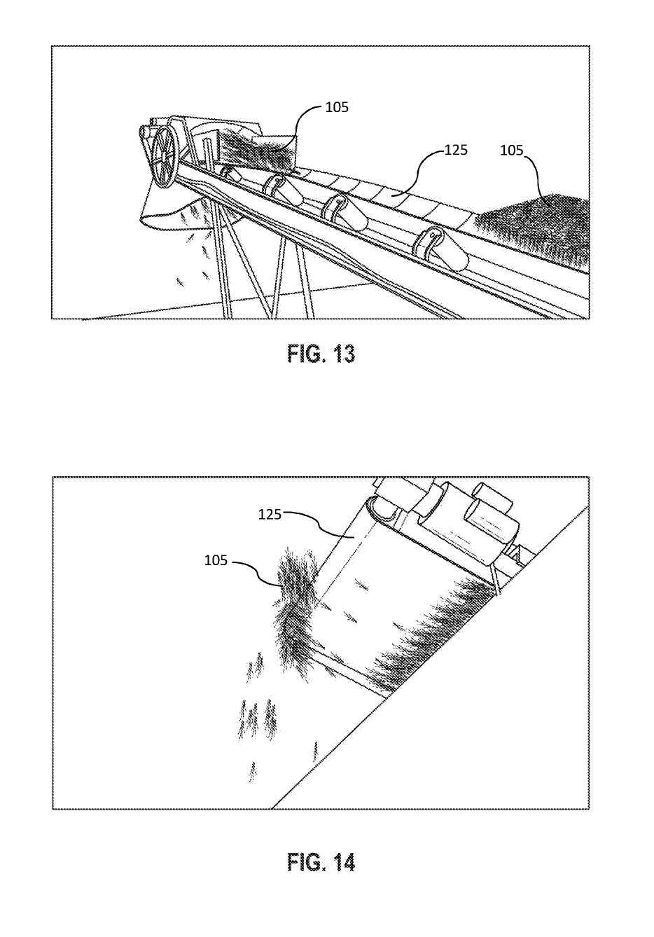

On the exit, or harvest, end of the hydroponic conveyor system, the sprout (or other plant product) is removed by the driving of the conveyor belt, which may be aided by a scraper 123 to ensure the sprouts are fully-removed. In one embodiment, as shown in FIGS. 7-14, the sprouts 105 are transferred (e.g., fall) onto an outfeed conveyor belt 122 which would transport the sprouts for further processing and/or storage or collection, such as by using loading conveyor 125. The outfeed conveyor belt 122 may, as shown in FIG. 15, deliver the fresh sprouts 105 directly to livestock. Additionally, by staggering the distribution of seeds and harvesting of the sprouts between conveyor belt rows in the rack 120, the user can program an expected harvest amount, or ration, at multiple harvest times per day. This would be useful for an operator to meet delivery schedules and pickup times without placing the product in a storage environment for unnecessary time intervals.

After every growth cycle, the buildup of plant matter along the conveyor belt 102 may accumulate to a point where conditions for disease may be encouraged. To combat that, a small dose of bleach may be applied by the moveable hydration arm. Additionally, ultraviolet light may also be used to help control an outbreak that would be detrimental to the sprouts.

Site utilities are preferably scalable, according to building production capacity, and preferably supply at least 3-phase 480-volt 200-600 amp service. Scalable potable water connections are preferably at least a ¾ inch 12 GPM supply. A wastewater connection could accommodate a four-inch drain pipe or suitable storm drain system or collection pond.

Some components of the hydroponic conveyor system may be actuated hydraulically, which may include the motors on the conveyor belts and outfeed conveyors, as well as processing and lifting equipment specific to the plant and for final delivery of the product/sprout.

The hydroponic conveyor system is automated, which requires the installation of automation controls. In one embodiment, low voltage wiring and communication cables are routed through designated conduit channels in an organized and serviceable manner. The installation includes the placement of all sensors and the connection and termination of the controls and monitors to the PLC. After final mapping procedures through the PHP networking equipment (or equivalent system), the software controlling the entire process can be deployed and the parameters for growing are entered. Testing and validation can also be performed. Further, the software is programmed to provide the proper levels of automatically dispensed seed 104, along with various controls for the hydration system, lighting, temperature and humidity control, sanitation, and final dispensing, distribution, or processing of the final product.

It is therefore appreciated that the present invention provides high-volume commercial production of high-quality sprouts with minimum manual intervention. The automation aspect of the hydroponic conveyor system disclosed herein provides a continual flow from seed to feed, guaranteeing a continual supply of sprouted grains to livestock feeding operations.

Additionally, multiple sprouts or crops may be produced in the same facility or group of facilities and meet customized supply solutions to varying supply and demand conditions. In other words, each row of conveyor belts 102 may have differing sprouts. Further, each facility may have one rack 120A, or more than one rack 120A and 120B. Any number of racks may be used. In one embodiment, the racks 120A, 120B are in a mobile facility (e.g., enclosed trailer) or are in a unit capable of being transported (e.g., large shipping container or equivalent). This allows the hydroponic conveyor system to be transported to a livestock farm, where fresh sprouts can be produced daily for the livestock.

Therefore, it is understood that the hydroponic conveyor system disclosed herein solves the need for a hydroponic system that can produce crops quickly and efficiently, without requiring large amounts of space or real estate, and where the crops can be harvested regularly—including daily in many instances.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A hydroponic conveyor system, comprising:
at least one conveyor belt;
a seed distributor for distributing seeds onto the conveyor belt;
a hydration system;
a plurality of light-emitting diodes; and
an HVAC system.

2. The system of claim 1, wherein the hydration system comprises a water tank for mixing nutrients therein.

3. The system of claim 1, wherein the hydration system comprises a moveable hydration arm located above a conveyor belt, wherein the moveable hydration arm comprises a plurality of drippers for dripping water on the conveyor belt.

4. The system of claim 1, further comprising a seed hopper for providing sees to the seed distributor.

5. The system of claim 1, wherein a plurality of conveyor belts are stacked vertically in a rack.

6. The system of claim 5, wherein the rack comprises curtains to form plenum walls.

7. A hydroponic conveyor system, comprising:
a plurality of conveyor belts stacked vertically in a rack, the conveyor belts forming rows in the rack, the conveyor belt divided into zones;
a plurality of seed distributors located in the first zone of the rack for distributing seeds onto the plurality of conveyor belts;
a hydration system comprising a moveable hydration arm in each row of the rack, each movable arm having a plurality of drippers for dripping water;
a plurality of light-emitting diodes in each row of the rack, the light-emitting diodes facilitating photosynthesis;
an HVAC system; and
an automation control system, wherein the automation control controls the speed of the conveyor belts and the timing of the hydration system.

8. The system of claim 7, further comprising a plurality of racks.

9. The system of claim 7, wherein the racks are fully-contained within a moveable housing.

10. A method of using conveyor belts for hydroponic growing, comprising:
distributing seeds onto at least one conveyor belt;
watering the seeds on the conveyor belt;
providing lighting to the conveyor belt to facilitate photosynthesis of the seeds thereon;
advancing the conveyor belt as the seeds sprout and grow; and
harvesting the sprouts at the end of the conveyor belt.
